(19) United States
(12) Patent Application Publication
(10) Pub. No.: US 2017/0251888 A1
(43) Pub. Date: Sep. 7, 2017

(54) PATTERNED LIQUID FLOW SKIN RINSER

(71) Applicant: THE FIRST HOSPITAL OF CHINA MEDICIAL UNIVERSITY, Shenyang (CN)

(72) Inventors: LI ZHANG, Shenyang (CN); XINGHUA GAO, Shenyang (CN); RUIQUN QI, Shenyang (CN); HONGDUO CHEN, Shenyang (CN); RUNXIAO LYU, Shenyang (CN)

(21) Appl. No.: 15/438,468

(22) Filed: Feb. 21, 2017

(30) Foreign Application Priority Data
Mar. 3, 2016 (CN) 201610119993.3

(51) Int. Cl. A47K 7/04; B08B 3/10; B08B 3/04

(52) U.S. Cl. CPC A47K 7/046; B08B 3/04; B08B 3/10; B08B 2203/007

(57) ABSTRACT

A patterned liquid flow skin rinser belongs to the technical field of an apparatus that simulates a liquid flow in a particular condition to rinse the skin of an organism, which in particular, relates to a patterned liquid flow skin rinser. The present invention provides a standardized patterned liquid flow skin rinser that is convenient to use and enables a simulated liquid flow to impact a skin surface. The present invention comprises a vertical casing, wherein in terms of its structure, the upper end of the casing is provided with a vertical water inlet, the upper portion of the side wall of the casing is provided with horizontal effluent transmission ports, the effluent transmission port is connected, through a vertical first recovery pipe, to a second recovery pipe that is disposed around the casing on the external side of the lower portion of the casing, the second recovery pipe is provided with an effluent recovery port, and a connection portion is disposed on the periphery of the lower end of the casing.

### TECHNICAL FIELD

The present invention relates to the technical field of an apparatus that simulates a liquid flow of a particular condition to rinse the skin of an organism, and in particular, to a patterned liquid flow skin rinser.

### BACKGROUND ART

In the health care industry, some medicine, cosmetics and the like often need to be applied onto a skin surface, and the skin surface applied with physical and chemical substances is sometimes rinsed by different liquids such as water while the substances are functioning; the remaining amount of these physical and chemical substances on the skin surface or inside the skin after rinse usually affects the effect of these physical and chemical substances. Detection of a rinse-resistant property of these physical and chemical substances becomes an index of concern in the industry. The rinse-resistant degree of the applied substance is closely related to a rinse manner, a rinse force, and rinse duration of a liquid, and during a detection process, usually an attempt is made to simulate contact manners in natural states, where these natural states include indoor shower, swimming in a swimming pool, swimming at the beach, and the like. A rinse parameter of a liquid flow in a natural state fluctuates significantly, and currently, a common practice in the industry is to let a subject stay in a commercially available whirlpool tub to take a rinse for a period of time, and then perform corresponding detection on the skin. However, the activity levels and postures of different subjects in the tub, an exact position of a subject with respect to a water outlet of the tub, and even different heights and body shapes of the subjects may affect detection data, causing an error. Different water quality in different regions may also affect data in detection centers distributed in different regions throughout the country or all over the world. The detection centers generally use daily tap water for detection, and it is difficult to simulate conditions such as high-salt seawater at the seaside and different water quality in different geographical regions by using existing detection devices and means. Before the test, the rinse fluid needs to be replaced frequently for different subjects or different physical or chemical reagents, which is time-consuming and water-consuming, and operators and subjects have relatively poor use experience.

### SUMMARY OF THE INVENTION

In view of the foregoing problem, the present invention provides a standardized patterned liquid flow skin rinser that is convenient to use and enables a simulated liquid flow to impact a skin surface.

To achieve the foregoing objective, the present invention uses the following technical solution: the present invention comprises a vertical casing, where in terms of its structure, the upper end of the casing is provided with a vertical water inlet; the upper portion of the side wall of the casing is provided with a horizontal effluent transmission port; the effluent transmission port is connected, through a vertical first recovery pipe, to a second recovery pipe that is disposed around the casing on the external side of the lower portion of the casing; the second recovery pipe is provided with an effluent recovery port; and a connection portion is disposed on the periphery of the lower end of the casing.

As a preferred solution, the casing of present invention is provided with a lateral water inlet above the second recovery pipe.

As another preferred solution, the casing of present invention is a cylindrical casing, the vertical water inlet is a cylindrical water inlet, the first recovery pipe is an inverted-L-shape recovery pipe, the second recovery pipe is an annular recovery pipe, and the effluent recovery port is horizontally arranged on the side wall of the second recovery pipe.

As another preferred solution, in the present invention, there are three first recovery pipes, which are evenly distributed along a circumferential direction of the casing.

As another preferred solution, in the present invention, an upper end of each first recovery pipe is provided with a vertical vent hole.

As another preferred solution, in the present invention, there are two lateral water inlets, which are horizontally arranged between two first recovery pipes, and the lateral water inlet is disposed in an inclined manner from top to bottom; one lateral water inlet is a lateral water inlet that forms an anticlockwise water flow inside the casing, and the other lateral water inlet is a lateral water inlet that forms a clockwise water flow inside the casing.

As another preferred solution, the connection portion of the present invention comprises a connection base and an annular portion that extends outwards from the lower end of the casing, three horizontal clamping blocks are evenly distributed on the external side of the annular portion along a circumferential direction of the annular portion, and the front end of the clamping block is provided with an inclined screw-in portion that is thin in the front and thick in the rear; the connection base comprises an annular base plate, the outer end of the annular base plate is a cylindrical side wall, the cylindrical side wall is provided with a vertical notch corresponding to the clamping block, the bottom end of one of side walls on two sides of the vertical notch is provided with a horizontal notch along a circumferential direction of the cylindrical side wall, and the width of the horizontal notch is set according to the front end of the screw-in portion.

As another preferred solution, in the present invention, between the cylindrical side wall and an inner ring of the annular base plate, the annular base plate is provided with an annular groove along the circumferential direction of the annular base plate, and a seal ring is disposed in the annular groove.

Secondly, in the present invention, the vertical water inlet is connected to an outlet of a water pump through a circulating water solenoid valve, an inlet of the water pump is connected to an outlet of a water tank, and an inlet of the water tank is connected to the effluent recovery port through a water suction solenoid valve.

Besides, in the present invention, the water tank is provided with an electric heater and a K-type thermocouple; one end of a power supply side of the electric heater is connected to one end of a controlled side of a solid-state relay (SSR) and one end of an indicator lamp HG3; the other end of the controlled side of the SSR is connected to one end of a fuse wire FU1, one end of an indicator lamp HR, one end of a push button switch SF1, one end of a push button switch SF3, and one end of a power supply side of a temperature controller through a push button switch SF2, respectively; the other end of the HG3 is connected to a mains neutral wire, the other end of the HR, one end of a power supply side of the water pump, one end of an indicator lamp HG1, one end of a power supply side of the water suction solenoid valve, one end of an indicator lamp HG2, the other end of the power supply side of the electric heater, one end of a control side of a relay KA1, one end of a power supply side of the circulating water solenoid valve, one end of an indicator lamp HG4, and the other end of the power supply side of the temperature controller, respectively; the other end of the FU1 is connected to a mains live wire; the other end of the SF1 is connected to the other end of the power supply side of the water pump, the other end of the HG1, and one end of a controlled side of the KA1, respectively; the other end of the controlled side of the KA1 is connected to the other end of the power supply side of the water suction solenoid valve and the other end of the HG2, respectively; the other end of the SF3 is connected to the other end of the control side of the KA1, the other end of the power supply side of the circulating water solenoid valve, and the other end of the HG4, respectively; and an output port of the K-type thermocouple is connected to a detection signal input port of the temperature controller.

The present invention has the following beneficial effects:

the upper end of the casing is provided with the vertical water inlet, so that an objective of direct flushing can be achieved;

water flows in through the vertical water inlet, so that the water quality of rinse water can be controlled;

the first recovery pipes, the second recovery pipe, and the effluent recovery port facilitate circulation and discharge of rise water, and the connection portion facilitates connection to a related part of a human body; and the present invention is convenient to use, and time and resources are saved.

The present invention provides a standardized simulation device that uses a liquid flow to impact a skin surface, where the device is specially used for the skin of an organism, and simulates a rinsing and washing effect of a liquid flow of a particular condition on the skin of an organism, so as to standardize the rinse direction and intensity.

### BRIEF DESCRIPTION OF THE DRAWINGS

The present invention is further described below with reference to the accompanying drawings and detailed description. The protection scope of the present invention is not limited to the description of the following content.

FIG. 1 is a schematic structural diagram of the present invention;

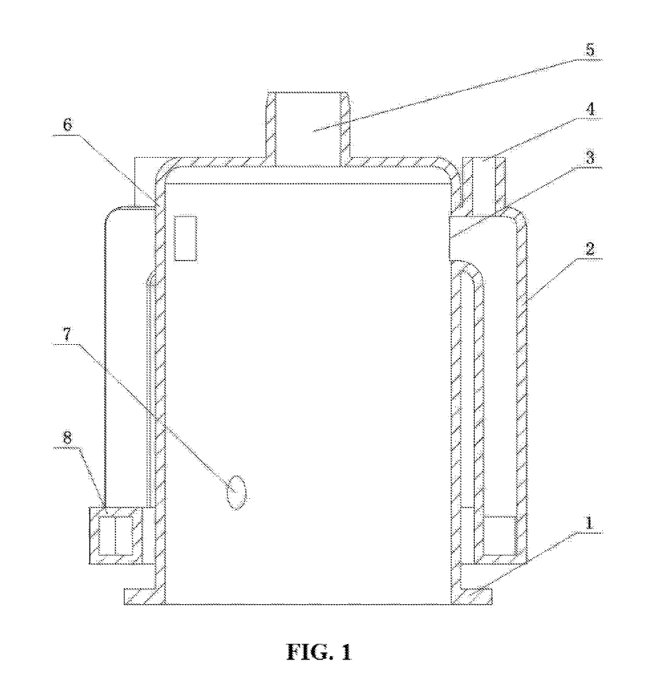

FIG. 2 is an external view of the present invention;

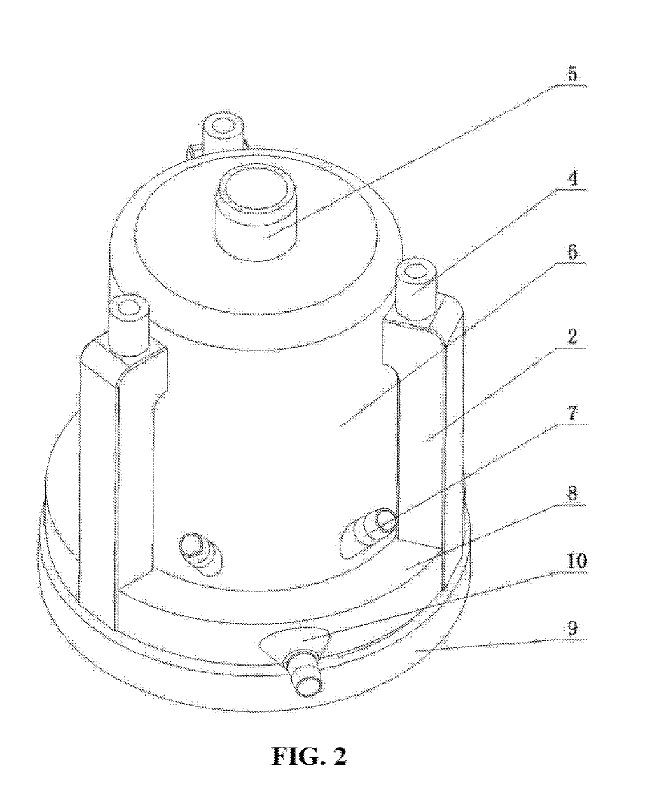

FIG. 3 is an external view of the present invention not connected with a connection base;

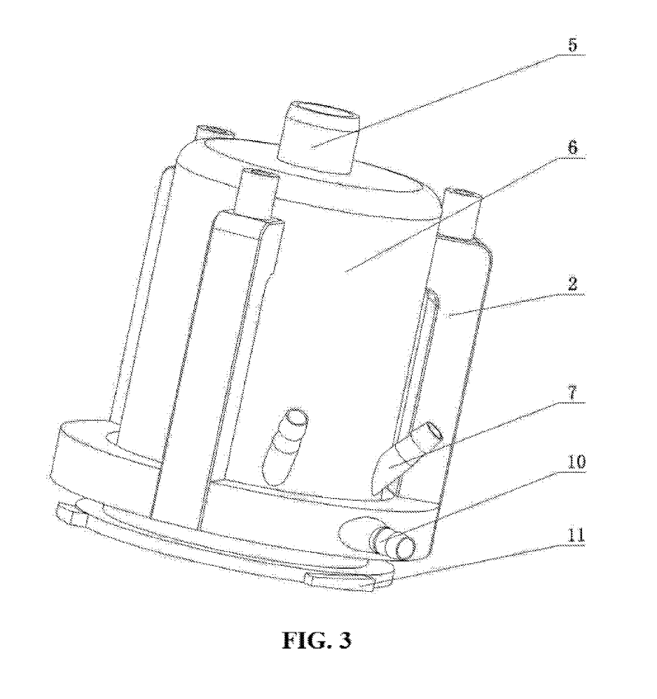

FIG. 4 is a schematic structural diagram of a connection base according to the present invention; and

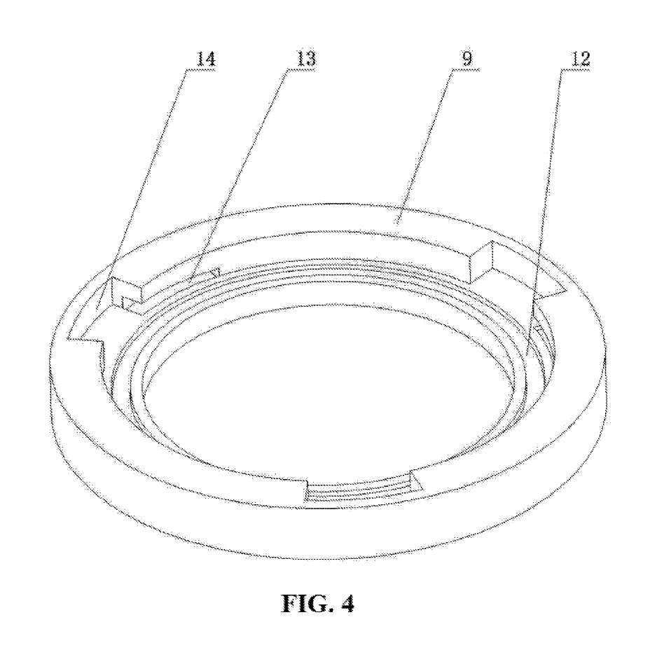

FIG. 5 is a schematic circuit diagram of the present invention.

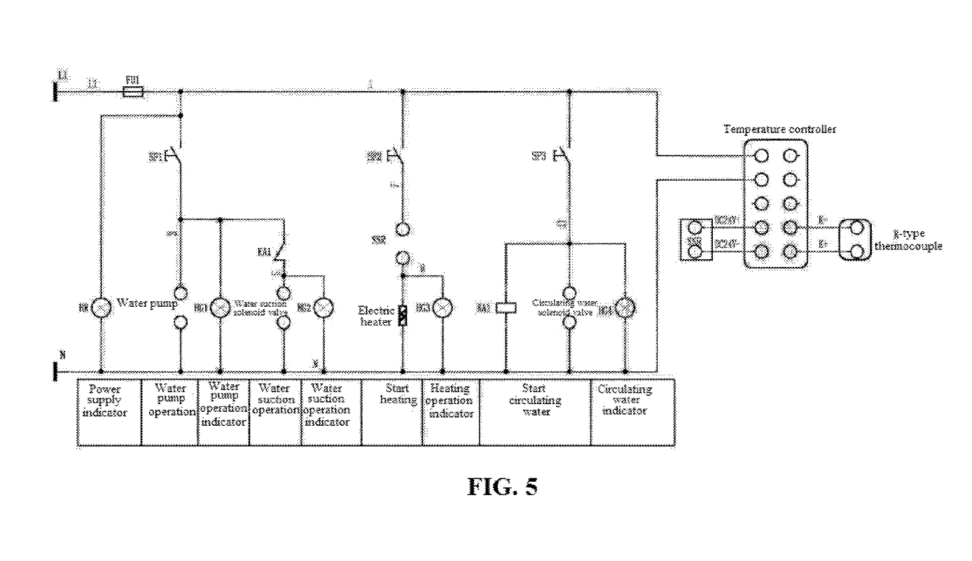

In the figures, 1 represents an annular portion; 2 represents a first recovery pipe; 3 represents an effluent transmission port; 4 represents a vent hole; 5 represents a vertical water inlet; 6 represents a casing; 7 represents a lateral water inlet; 8 represents a second recovery pipe; 9 represents a connection base; 10 represents an effluent recovery port; 11 represents a clamping block; 12 represents an annular groove; 13 represents a horizontal notch; and 14 represents a vertical notch.

### DETAILED DESCRIPTION

As shown in the figures, the present invention comprises a vertical casing 6, where the upper end of the casing 6 is provided with a vertical water inlet 5; the upper portion of the side wall of the casing 6 is provided with horizontal effluent transmission ports 3; each effluent transmission port 3 is connected, through vertical first recovery pipes 2, to a second recovery pipe 8 that is disposed around the casing 6 on the external side of the lower portion of the casing 6; the second recovery pipe 8 is provided with an effluent recovery port 10; and a connection portion is disposed on the periphery of the lower end of the casing 6.

The casing 6 is provided with lateral water inlets 7 above the second recovery pipe 8.

The casing 6 is cylindrical, the vertical water inlet 5 is cylindrical, each first recovery pipe 2 is inverted-L-shaped, and the second recovery pipe 8 is annular; and the effluent recovery port 10 is horizontally arranged on the side wall of the second recovery pipe 8.

Three said first recovery pipes 2 are provided, which are evenly distributed along a circumferential direction of the casing 6, to facilitate uniform transmission of the liquid in the casing 6.

The upper end of each first recovery pipe 2 is provided with a vertical vent hole 4.

Two said lateral water inlets 7 are provided, which are horizontally arranged between two first recovery pipes 2, and are disposed in an inclined manner from top to bottom. One lateral water inlet 7 is one that forms an anticlockwise water flow inside the casing 6, and the other lateral water inlet 7 is one that forms a clockwise water flow inside the casing 6. By providing the two lateral water inlets 7, a better simulation effect can be achieved. The two lateral water inlets 7 may take in water at different times.

The connection portion comprises a connection base 9 and an annular portion 1 that extends outwards from the lower end of the casing 6. Three horizontal clamping blocks 11 are evenly distributed on the external side of the annular portion 1 along a circumferential direction of the annular portion 1, and the front end of each clamping block 11 is provided with an inclined screw-in portion that is thin in the front and thick in the rear. The connection base 9 comprises an annular base plate, the outer end of the annular base plate is a cylindrical side wall, and the cylindrical side wall is provided with vertical notches 14 corresponding to the clamping blocks 11. The bottom end of one of side walls on two sides of each vertical notch 14 is provided with a horizontal notch 13 along a circumferential direction of the cylindrical side wall, and the width of the horizontal notch 13 is set according to the front end of the screw-in portion.

Between the cylindrical side wall and an inner ring of the annular base plate, the annular base plate is provided with an annular groove 12 along the circumferential direction of the annular base plate, and a seal ring is disposed in the annular groove 12. By providing the seal ring, leakage of water in the casing 6 can be effectively prevented.

The vertical water inlet 5 is connected to an outlet of a water pump through a circulating water solenoid valve, an inlet of the water pump is connected to an outlet of a water tank, and an inlet of the water tank is connected to the effluent recovery port 10 through a water suction solenoid valve. By providing the solenoid valves and the water pump, a rinse speed can be standardized.

The water tank is provided with an electric heater and a K-type thermocouple. One end of a power supply side of the electric heater is connected to one end of a controlled side of a solid-state relay SSR and one end of an indicator lamp HG3; the other end of the controlled side of the SSR is connected to one end of a fuse wire FU1, one end of an indicator lamp HR, one end of a push button switch SF1, one end of a push button switch SF3, and one end of a power supply side of a temperature controller through a push button switch SF2, respectively; the other end of the HG3 is connected to a mains neutral wire, the other end of the HR, one end of a power supply side of the water pump, one end of an indicator lamp HG1, one end of a power supply side of the water suction solenoid valve, one end of an indicator lamp HG2, the other end of the power supply side of the electric heater, one end of a control side of a relay KA1, one end of a power supply side of the circulating water solenoid valve, one end of an indicator lamp HG4, and the other end of the power supply side of the temperature controller, respectively; the other end of the FU1 is connected to a mains live wire; the other end of the SF1 is connected to the other end of the power supply side of the water pump, the other end of the HG1, and one end of a controlled side of the KA1, respectively; the other end of the controlled side of the KA1 is connected to the other end of the power supply side of the water suction solenoid valve and the other end of the HG2, respectively; the other end of the SF3 is connected to the other end of the control side of the KA1, the other end of the power supply side of the circulating water solenoid valve, and the other end of the HG4, respectively; and an output port of the K-type thermocouple is connected to a detection signal input port of the temperature controller. By providing the K-type thermocouple and the temperature controller, it is convenient to control water temperature, thereby achieving a more comprehensive simulation effect.

In use, the present invention may be locked on the back of a human body, and get in contact with the back through the connection portion, where the human body keeps a prone posture; and the lower end of the connection portion may be applied with a sealing adhesive to prevent water from flowing out.

It can be understood that, the foregoing specific description about the present invention is merely used to illustrate the present invention but is not limited to the technical solutions described in the embodiments of the present invention. A person of ordinary skill in the art should understand that, modifications or equivalent replacements can still be made to the present invention to achieve the same technical effect, and any modification or equivalent replacement that meets the usage requirement falls in the protection scope of the present invention.

What is claimed is:

1. A patterned liquid flow skin rinser, comprising a vertical casing, wherein the upper end of the casing is provided with a vertical water inlet; the upper portion of the side wall of the casing is provided with a horizontal effluent transmission port; the effluent transmission port is connected, through a vertical first recovery pipe, to a second recovery pipe that is disposed around the casing on the external side of the lower portion of the casing; the second recovery pipe is provided with an effluent recovery port; and a connection portion is disposed on the periphery of a lower end of the casing.

2. The patterned liquid flow skin rinser of claim 1, wherein the casing is provided with lateral water inlets above the second recovery pipe.

3. patterned liquid flow skin rinser of claim 2, wherein the casing is a cylindrical casing, the vertical water inlet is a cylindrical water inlet, the first recovery pipe is an inverted-L-shaped recovery pipe, the second recovery pipe is an annular recovery pipe, and the effluent recovery port is horizontally arranged on the side wall of the second recovery pipe.

4. The patterned liquid flow skin rinser of claim 1, wherein there are three first recovery pipes, which are evenly distributed along a circumferential direction of the casing.

5. The patterned liquid flow skin rinser of claim 1, wherein the upper end of the first recovery pipe is provided with a vertical vent hole.

6. The patterned liquid flow skin rinser of claim 2, wherein there are two lateral water inlets, which are horizontally arranged between two first recovery pipes, and the lateral water inlet is disposed in an inclined manner from top to bottom; one lateral water inlet is a lateral water inlet that forms an anticlockwise water flow inside the casing, and the other lateral water inlet is a lateral water inlet that forms a clockwise water flow inside the casing.

7. The patterned liquid flow skin rinser of claim 1, wherein the connection portion comprises a connection base and an annular portion that extends outwards from the lower end of the casing, three horizontal clamping blocks are evenly distributed on the external side of the annular portion along a circumferential direction of the annular portion, and the front end of the clamping block is an inclined screw-in portion that is thin in the front and thick in the rear; the connection base comprises an annular base plate, the outer end of the annular base plate is a cylindrical side wall, the cylindrical side wall is provided with a vertical notch corresponding to the clamping block, the bottom end of one of side walls on two sides of the vertical notch is provided with a horizontal notch along a circumferential direction of the cylindrical side wall, and the width of the horizontal notch is set according to the front end of the screw-in portion.

8. The patterned liquid flow skin rinser of claim 7, wherein between the cylindrical side wall and an inner ring of the annular base plate, the annular base plate is provided with an annular groove along a circumferential direction of the annular base plate, and a seal ring is disposed in the annular groove.

9. The patterned liquid flow skin rinser of claim 1, wherein the vertical water inlet is connected to an outlet of a water pump through a circulating water solenoid valve, an inlet of the water pump is connected to an outlet of a water tank, and an inlet of the water tank is connected to the effluent recovery port through a water suction solenoid valve.

10. The patterned liquid flow skin rinser of claim 9, wherein the water tank is provided with an electric heater and a K-type thermocouple; one end of a power supply side of the electric heater is connected to one end of a controlled side of a solid-state relay SSR and one end of an indicator lamp HG3; the other end of the controlled side of the SSR is connected to one end of a fuse wire FU1, one end of an indicator lamp HR, one end of a push button switch SF1, one end of a push button switch SF3, and one end of a power supply side of a temperature controller through a push button switch SF2, respectively; the other end of the HG3 is connected to a mains neutral wire, the other end of the HR, one end of a power supply side of the water pump, one end of an indicator lamp HG1, one end of a power supply side of the water suction solenoid valve, one end of an indicator lamp HG2, the other end of the power supply side of the electric heater, one end of a control side of a relay KA1, one end of a power supply side of the circulating water solenoid valve, one end of an indicator lamp HG4, and the other end of the power supply side of the temperature controller, respectively; the other end of the FU1 is connected to a mains live wire;
the other end of the SF1 is connected to the other end of the power supply side of the water pump, the other end of the HG1, and one end of a controlled side of the KA1, respectively; the other end of the controlled side of the KA1 is connected to the other end of the power supply side of the water suction solenoid valve and the other end of the HG2, respectively; the other end of the SF3 is connected to the other end of the control side of the KA1, the other end of the power supply side of the circulating water solenoid valve, and the other end of the HG4, respectively; and an output port of the K-type thermocouple is connected to a detection signal input port of the temperature controller.
